(19) United States
(12) Patent Application Publication
(10) Pub. No.: US 2001/0054001 A1
(43) Pub. Date: Dec. 20, 2001

(54) System and method for advertising

(76) Inventor: Gary B. Robinson, Bangor, ME (US)

Correspondence Address: Gary S. Morris, Kenyon & Kenyon, Suite 700, 1500 K Street, N.W., Washington, DC, 20005, US

(21) Appl. No.: 09/802,957

(22) Filed: Mar. 12, 2001

Related U.S. Application Data
(60) Provisional application No. 60/188,939, filed on Mar. 10, 2000.
(60) Provisional application No. 60/189,600, filed on Mar. 15, 2000.

(51) Int. Cl. G06F 17/60

(52) U.S. Cl. 705/14

(57) ABSTRACT

A system and method for targeting advertising. Advertising targeting information is stored on a client. Such information can be sensitive information that the user wishes to remain confidential. An advertisement is selected at the client for display to the user, based upon the advertising targeting information stored at the client. This can be accomplished using a software agent at the client. The selected advertisement may be retrieved from client memory, or a request can be sent to a remote server to send the selected advertisement to the client.

This application claims the benefit of U.S. Provisional Patent Application No. 60/188,939 filed on Mar. 10, 2000, and U.S. Provisional Patent Application No. 60/189,600 filed on Mar. 15, 2000.

### FIELD OF THE INVENTION

The field of the invention is advertising, and in particular targeted advertising.

### BACKGROUND OF THE INVENTION

Currently, there is a great deal of controversy involving possible privacy violations with regard to advertising on the World Wide Web. In particular, cookies are used to track users and store behavioral data in a server. Also, that data can be linked to data in other databases which may contain such information as a user's name and address.

The greatest threat to privacy on the Internet and other current and future online systems is that, to better target advertising toward the likely interests of each individual consumer, advertising organizations are motivated to combine as much information about each consumer as possible in one place. The more data is stored in such a central location for each user, the more data there is to base ad targeting on, and the more accurate that targeting is likely to be.

### SUMMARY OF THE INVENTION

In accordance with an embodiment of the present invention, the user's demographic and behavioral information (where the behavioral information may involve tracking Web browsing activities), never needs to leave the user's machine, and yet it is still used to achieve a degree of ad targeting consistent with the state-of-the-art.

Purchase history information, stored on servers of advertising merchandisers, is also taken advantage of for targeting. It is combined with demographic and behavioral information, as well as purchase history information from other merchandisers, only on the computer of the user in question.

In one embodiment, software is running in the machine of the consumer in which the choice is made regarding which ad to show the consumer at a given time. As one example, this software could be a plug-in to a Web browser. As another, it could be separate ad-displaying software such as that marketed by pay-to-surf companies, such as that once provided by AllAdvantage, or used by certain free ISP services. This software will be referred to as the “ad-targeting agent environment” or “agent environment.”

One aspect of the present invention lies in recognizing that a competitive market for targeting algorithms is likely to result in superior technology than in relying on whatever technology happens to be provided by the ad hub vendor. (‘The term “ad hub vendor” will refer to companies such as DoubleClick which receive advertisements from advertisers and their advertising agencies and distribute them to various Web sites. Advertisers and their agencies will be generally referred to as “advertisers.”) Indeed, it is possible that different technologies will be optimal for different ads or types of ads.

The ad-targeting agent environment therefore receives and executes algorithms (“agents”) from advertisers, which may have created them in-house or acquired them from elsewhere. Each advertiser is free to use whichever algorithm it deems most appropriate for its ad(s). In a typical Internet-based embodiment, these agents are streamed to agent environments, running on the user's machine, from the advertiser's servers or servers running at the hub vendor.

Data is provided to these agents to help them do their work. For instance, demographic and job-related data for the user may be provided, and behavioral data may be provided. Note that this data does not have to leave the user's machine.

At this point in the discussion we have multiple agents, supplied by multiple advertisers, running in an agent environment in the user's machine. Each agent has access to the relevant data, knowledge of one or more ads, and responsibility for causing such ads to be displayed. There remains a need to arbitrate between these agents, and to choose which single ad (in typical implementations) to display at a particular time.

One entity that fills this need will be referred to as the “Arbitration Module.”

Various embodiments have different types of Arbitration Modules. Several embodiments will be described in this specification. It should not be construed that the invention is limited to any particular types of Arbitration Modules.

The output of the agents, which is processed by the Arbitration Module in order to decide which ad to show at a given time, may be thought of as a bid. The Arbitration Module collects the bids and chooses the most “attractive” one.

In some embodiments, the bids are in some currency such as U.S. dollars; the highest bid wins. In others, more abstract quantities are used. In one particularly simple embodiment, the bids may only have two states, which may be represented by 0 and 1, indicating whether the agent wants to show the ad to the user of the machine at the current time.

To resolve this need, means are provided for the agents to bid to display a particular ad. For instance, if a user has entered personal data indicating that he is a highly-placed buyer of computers for his company, and has further indicated an interest in the Linux operating system, than an agent for an ad for a new Linux-based computer may place a high bid to place that ad. Agents for ads for dishwashing detergent may generate lower bids, and the Linux computer ad will then be displayed.

In some implementations, these agents have knowledge of the current location of the user. (For instance, in embodiments where the agent environment is part of a Web browser, the URL of the Web site currently being visited could easily be passed to the agent.) Agents can then incorporate that information into their bids. For instance, the agent for the Linux computer ad may bid more while the user is browsing a site containing reviews of Linux-based hardware than it would while the user is browsing a site for sending flowers since, in the former case, he is more likely to be in the mind set to click on such an ad.

Some embodiments additionally facilitate a further means for improving the targeting. In one case, the supplier of the agent environment service (“agent environment supplier”) makes individual requests for agents for individual users. For instance, it may send identifying information about the user, for instance, his name and address, to certain advertisers. In most cases, such information is only sent to advertisers with whom an agreement has been worked out with the provider of the agent environment service, and is sent on a secure connection. Usually, no information is sent which that individual provider does not already have on file (in some cases, the user name may be all that is sent, in other cases additional identifying information is provided). This information may then be used by the advertiser in generating an agent to send to a particular person. For instance, if an advertiser's database says that the user has already bought a number of particular type of Linux-based computer from that advertiser, a relatively high bid may be placed for an ad for a new and improved model in that line. Note that this procedure still has some effectiveness even when the user cannot be uniquely identified. For instance, there may be two people in the advertiser's database with the same name, only one of which has bought a large amount of equipment. It would still make sense to place a relatively high bid on the ad for the improved computer, even if the bid should be a little less than in the case of unique identification. (Note that agents may alternatively contact the advertisers' servers to get purchase history information; the agent may be given access to basic identifying information like the user's name and address and can use that to obtain purchase history information from the advertiser's server. In this case, again, user privacy is not compromised; the advertiser is not receiving any information it doesn't already have, and it isn't going anywhere but to an agent in the user's machine.)

In some embodiments, the identifying information is stored on the user's machine and relayed from the agent environment container, to the service provider, and on to the advertisers in real time. Thus, there is no need for the service provider to store such identification information in its own central database, and in any case there is no need for it to be associated with any demographic, behavioral, or other kinds of data either in the service provider's machines or in advertiser's machines. The only place where all this data is stored together is on the user's own machine; indeed, this collection isn't made available to any other entity but the user's machine.

Because personal data is never made available on the network, it is impervious not only to ill-intentioned company executives and to hackers, but also to the government via serving the advertiser or ad hub vendor with a subpoena.

It should be noted that a further advantage of this invention is that its computational model is fundamentally distributed. One concern that has is sometimes raised with respect to advanced targeting techniques is that a great number of decisions regarding what ad to show a particular person must be made each second. If all the processing is done in the hub vendor's machines, limitations of CPU power may lessen the amount of processing that can be done and therefore the sophistication of the targeting algorithms. The distributed model of the current invention greatly lessons those concerns, because real-time decisions are made by software running in the client's machine.

In summary, the present invention eliminates all privacy concerns while simultaneously enabling greater accuracy of targeting than exists in the prior art.

### BRIEF DESCRIPTION OF THE DRAWINGS

FIG. 1 shows the method in accordance with a first embodiment of the present invention.

FIG. 2 shows the method in accordance with a second embodiment of the present invention.

FIG. 3 shows the method in accordance with a third embodiment of the present invention.

FIG. 4 shows the method in accordance with a fourth embodiment of the present invention.

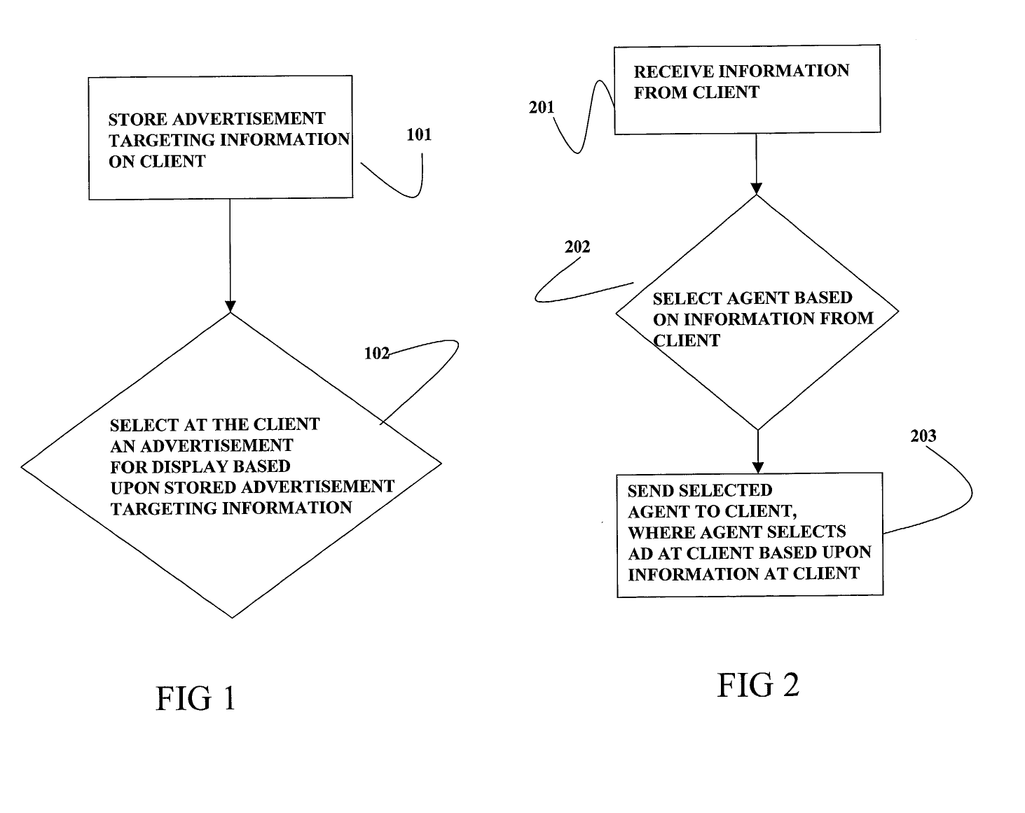

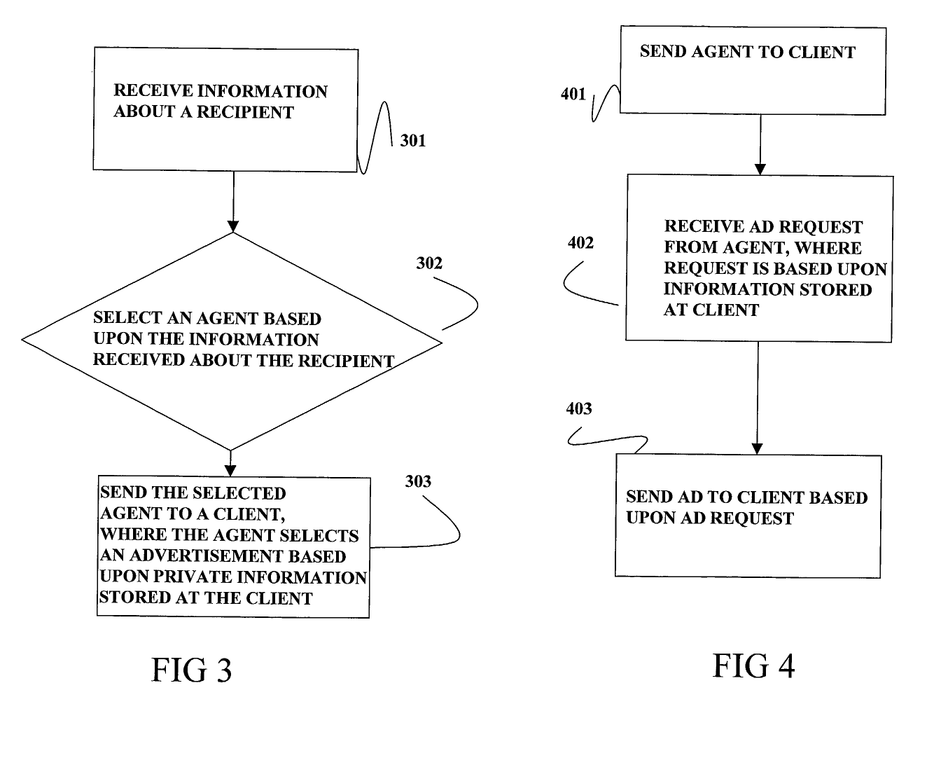

### DETAILED DESCRIPTION

Tuning the Bids

One aspect of the advertising industry that needs to be considered is that traditionally, advertisers pay a fixed amount of money for a fixed number of exposures. When advertisers advertise in newspapers, they know the circulation and calculate the CPM. On the Web, fees have also been by CPM or equivalent calculations. So, even though we are engaging in case-by-case bidding, the present invention, in some embodiments, provides means to also plan an ad campaign based on CPM.

But the reality in the bid-based world described by the invention is that the advertiser can't independently control the cost and the schedule. If the agent for an ad tends to bid high (which weakens the targeting since bids will win for less-targeted situations), it will take longer to win enough auctions display a particular number of ads than will be the case if the agent tends to bid low. Thus, the advertiser pays for timeliness. The advertiser needs to decide, not only what a display of an ad to a user with particular characteristics is worth, but also how much it is worth to have displays to that and other users occur in a short time frame.

Agents may be replaced by the advertiser at times of the advertiser's choosing or at predefined increments, according to the embodiment. This provides a mechanism for adjusting the time vs. cost. If the number of bids won by an agent per day or week is too low for the desired schedule, the agent can be modified to place higher bids. If the agent appears to be generating the desired number of page views more quickly than the schedule requires, the agent can be adjusted to bid lower. Some embodiments provide tools to assist in adjusting agents for these factors. When an ad is placed by winning a bidding process, there are numerous ways the amount of the winning and losing bids, together with the identity of the ad, can be received by the hub vendor's servers. For instance, in embodiments where the ad is served from the hub vendor's servers, the bid amounts can be placed in a cookie which would accompany the request to serve the ad; the cookie could be read and processed as part of the ad serving process. In some embodiments, whenever a bid is won, a record of the ad and bid amount (without any user-identification information) is sent via a TCP/IP socket connection to the server; this record can be plain text, for instance, it could be an extremely simple XML string. Other approaches are possible within the scope of the invention.

Using this information, estimates can be made regarding the probability that a particular bid will be accepted. One way to do this is to make a list of bid amounts, for example, at quarter-cent increments, together with the proportion of wins in each range. For example, if the maximum realistic bid is 10 cents, then an array with 40 entries can be constructed at quarter-cent intervals; each entry contains the proportion of winning bids.

In some embodiments, this array is then made available to advertisers in order to help them construct their agents. The amounts in the array will change over time as the advertising climate changes, so some embodiments supply an automated way to receive updates; for example, the information can be stored in an XML format and served on the Internet to advertisers whenever they want to get an update.

In related embodiments, no such incremental array is constructed, but advertisers can request (for instance, using XML-RPC on the Internet), to find the number of bids and the percentage of winning bids that have occurred between any two amounts.

In addition, some embodiments provide category information along with these numbers, since different winning bid ranges will occur in different categories. The categories may be tied to the ad displayed and/or the page it was displayed on, depending on the embodiment, and whether the particular embodiment has access to page information.

In some embodiments, proportions are computed with a weighted average approach where older information has less weight. For instance, in one such embodiment a cumulative exponential distribution based on time is used to determine the weights commensurate with the “half life” the value of the data points is thought to have (a practitioner of ordinary skill in the field of statistics will be able to form the weights according to this model).

In other embodiments, the weight earlier than some amount of elapsed time is 0, and the weight for newer data is 1. If the volume of advertising in each category is enough, this approach may be adequate, because there will be more than enough recent data to generate estimates of proportions of winning bids in given ranges. This procedure works not only for standard auction embodiments, but also for binary bidding environments, where the number of 1's generated by a typical agent population is simulated. In testing, this allows the system to determine how long it will take for an agent to display its ad a particular number of times, enabling an agent to be adjusted over time to facilitate a fixed-schedule, fixed-cost ad campaign.

A further embodiment uses this data to generate a table to simulate many bids over time. One example is to generate a 2-dimensional table indexed on mean and standard deviation, showing the percentage of bids that can be expected to be won by an agent showing each particular mean and standard deviation in its bids. This table can be built by simulation.

A further tool provided by the hub vendor in some embodiments is a database of “sample” users that mirrors the distribution of characteristics of the entire population. Such a mirroring population is traditionally used by market researchers in studying the response to products and advertisements. In many cases such populations of research subjects are paid or given free products to motivate them to give their information. Such a population will obviously not be independently claimed in this invention.

These tools, when combined, enable the builders of agents (whether they be automated or human) to do testing in-house before sending their agents out to user machines. This testing will enable agents to be run in a simulation environment in which the frequency of wins in real-world use can be anticipated. The agent will be run against the research users, with bid amounts collected in actual use (“real” bids do not need to be generated in this testing by other agents, replaying the collected data will do), and the proportion of wins per bid calculated.

In some implementations, this testing environment exists at the hub vendor's servers; agents to be tested are sent there and tested. In other implementations, the data and related software tools are made available for use at the advertiser's locations.

Mechanics of Bidding

For each “slot” in which an ad can be placed, be it a viewing of a banner ad on a Web page or the display of a full-screen ad on an interactive television where the agent environment resides in a “set-top box,” an auction is conducted. The various agents bid for the slot.

In one embodiment, the agent environment then chooses the highest bid and causes that ad to be displayed. In addition, some embodiments store the bids, in some cases in an array sorted in order from highest to lowest, so that if no new information is available necessitating new bids, a series of ads can be displayed without the computational expense of generating new bids.

In general, there are many approaches to auctioning off a resource which are well-known to practitioners of ordinary skill in the arts of economics and game theory. The present invention is not limited to any particular auction method. However, it should be noted that the Vickrey auction, which involves giving the resource to the highest bidder but at the second-highest price, has the advantage of motivating the agents to give their true valuations of the resource in their bids. The difference between the highest bid and the second highest bid can then be looked at as the cost of motivating this revealing of information, which leads to a more reliable auction process if the agents are truly rational. For more information, see [1] or other studies on the subject of Vickrey and other types of auctions.

In some embodiments, a Vickrey auction is used, in accordance with the algorithm described in Hal R. Varian, “Economic Mechanism Design for Computerized Agents,” <http://www.sims.berkeley.edu/-hal/people/hal/papers.html>. In other embodiments, other auction models are used.

Depending upon the embodiment, bidding can occur either in real time or well in advance of the actual ad display.

An advantage to bidding in real time, in cases where the agent environment implementation has knowledge of the current activities of the user (for instance, the identity of the Web page being viewed), is that bids can incorporate the current mind set of the user, as discussed elsewhere.

For instance, in some embodiments, every time the user moves to a different Web page, new bids are generated which take that new location into account.

In some embodiments, new bids are solicited every time a new ad or agent is made available by one of the advertisers, which may be in addition to the new bids generated in response to other events.

Agents can be responsible for a single advertisement, or can have responsibility for more than one advertisement.

In one typical embodiment, when new bids are requested, bids take the form of ad/bid amount pairs. In this embodiment, the ad is represented by a character string giving its URL, and the bid amount is the number of cents (which may involve fractional cents) for an ad display. Other embodiments use other methods for specifying bids. For instance, ads may be specified by a unique integer representing an ad, or by character string names for the ads which are not directly associated with the URL. If an agent is responsible for bidding for more than one ad, it can decide within itself which ad will receive its highest bid for the current slot, and only that bid needs to be revealed to the agent environment.

Binary Bids—The Simplest Form

In this embodiment, agents generate an ad which simply indicates whether the agent has a decided that the ad should be shown to the current user (and, in embodiments where timing is relevant, at the current time). This indicator may, for example, be 0 when a showing is not desired, and 1 when it is. This version of the indicator will be referred to in the rest of this discussion, however other versions are to be considered to be equivalent.

Due to the simplicity of the model, it wouldn't normally be referred to as an “auction,” except that it can be viewed as a very simple auction for purposes of consistency and simplicity of discussion.

This model is arguable the one that is simplest for advertisers to work with and that produces the least change from their current way of doing things. Agents simply need to be able to compute whether or not the advertiser wishes to show an ad to a particular person. In current ad-targeting technology, the same computation occurs; this invention moves it to the user's machine and introduces means of arbitrating between multiple advertisers (through their agents) who want to show the same ad to the same person at the same time.

In cases where more than one agent outputs a 1, the Arbitration Module needs to choose between them. Several embodiments will be discussed which solve this problem in different ways. The present invention is not restricted to any particular solution to this problem; the solution in a given embodiment may be one of those listed here or another solution.

In a first embodiment, an ad is chosen at random from those that bid 1.

In a second embodiment, a list is created of all ads for which 1 was bid. The order of ads in the list may be random, alphabetical by file name, or any other ordering. They are displayed in list order without intervening auctions occurring. In a variant to this embodiment, if conditions change that merit a new auction (for instance, if the user moves to another Web page which has a different subject matter, and if the overall embodiment supplies information about the currently viewed page to agents), the list is dropped and a new auction run, even if not all ads on the list have been viewed. In a further variant, the list is stored and Arbitration Module continues where it left off the next time conditions are the same (for instance, the user returns to the Web page in association with which the list was originally created).

In a third embodiment, when an auction is conducted, “credits” are considered by the Arbitration Module in choosing which ad to display. Credits are earned by outputting a 1 but not having the corresponding ad shown due to losing out in a random choice for which ad to display. One credit is earned every time that happens. After all the bids are made in a round, the ad for which a 1 was bid and which has the most credits associated with it is chosen for viewing. If there is a tie with regard to the highest number of credits, one of the tied ads is chosen randomly.

In most embodiments of the invention where the Arbitration Module employs the binary model, advertisers are charged the same amount for every ad showing. Thus, there is no problem with charging advertisers by CPM.

The other issue is timing; an advertiser may want a particular number of exposures to occur within a particular time frame. This is a matter of the threshold at which the agent bids a 1. For example, an agent may require most of the user's demographics to line up 1 with the target group before it bids a 1, or it may require just a few to line up. In general, agents in the binary model can have the same internal construction as more complex models where real, non-binary bidding takes place, but translate this non-binary “bid” into a binary bid by outputting 1 if the non-binary bid is over a particular threshold. Then, to show ads more frequently, the agent's threshold for outputting a 1 simply needs to be lowered.

Thus, if it is determined that an ad is being shown too infrequently, a new agent can be constructed for it that is identical to the first one but with a lower threshold. This process can be repeated until the rate of ad displays is consistent with the advertising schedule.

Real-valued Bids, Non-monetary

In some embodiments, agents “bid” a real number which represents the confidence the agent has the ad should be shown to the user in question at the time in question. The ad shown is the one associated with the highest bid.

The real number does not represent a limited resource as it would if money were being bid. That is, the agent can place extremely high bids every time if it wants to without using up resources. However there is a very good reason not to do that: the benefits of targeting would be lost.

So, even without a limited resource being bid, agents make high and low bids depending on the particular user.

An advantage of this approach over binary bidding is that advertisers who value a user more have their ads shown before those of advertisers who want to reach a user, but value him somewhat less.

Theoretically, no rules at all have to be given regarding the bids. Agents that tend to bid too high relative to other agents will lose some or all of the benefits of targeting; agents that tend to bid too low will take too long to have their ads displayed. So both types of outliers will tend to converge toward the average in order to advertise more effectively. So, over time, it can be argued that all the advertisers will converge to a range of bids that will work well for the entire agent population.

However, that would take a long time and there is no need to take that approach. Instead, a standard scale should be suggested. Other scales may be used as well.

This scale ranges from 0 to 1, and represents the proportion of users and contexts that are thought to be less valuable than the present one.

For example, let's once more consider an ad for a Linux box. Suppose the data shows that the current user is a high-level buyer for a well-funded company, that he has bought a number of Linux boxes in the past, and that he is currently browsing a Linux-oriented site. Then, an advertiser selling new Linux boxes may conclude that this user is more valuable than 99% of the general user population. So the bid would be 0.99. Now suppose the same user is browsing a flower-sending site. He's the same user, but now less reliably in the mind set to spend his time looking into an ad for a Linux box—he's busy trying to get flowers sent to someone. So he may not be considered to be a better target than 85% of the population rather than 990. The bid in this case would be 0.85.

Some embodiments of the invention describe a suggested scale on the agent environment vendor's site, so that agent designers can refer to it.

Note that it is possible to mix the binary and real-valued bidding models, since binary bids can be made equivalent to a particular real number. That is, some agents may produce binary output and some may produce real output. Some embodiments assign the same real numbers to the two possible outputs for all binary agents (for instance, 0 and 0.75); some allow each binary agent to set its own output (these agents may have the same interface as real-valued agents, but always output one of two fixed values).

Varying Monetary Bids

In some embodiments, money is used in bidding. In most such embodiments, the winning bid is the amount paid to display the ad.

One advantage of this is that advertisers pay for the value they receive with every bid and every user.

However, a further advantage of monetary bids lies in embodiments where users receive part of the money paid by advertisers.

There are existing advertising systems which share revenue, an example having been AllAdvantage. However, in known prior art, the amount the user receives is fixed. (For instance, AllAdvantage paid 50 cents per hour.) In the present invention, the more demographic data he specifies about himself and the more other information he allows to be made available (for instance, by allowing the installation of special software to do the tracking on his machine, or by pressing a button on an advertiser's site allowing an identity means to be engaged to assist in using purchase history data to in targeting), the more confident some agents will be that the user should see an ad, and the more they will bid. Thus, the user is compensated appropriately for the amount of information he has made available. For instance, this occurs in embodiments where the revenue paid to the user is a fixed proportion of each winning bid. This has the effect of motivating the user to help advertisers by making more personal information available to the system.

In some embodiments, an additional feature is provided to further motivate users to make more information available. An input means is provided by which the user specifies that he wants to see how much money he will make if he makes more information available.

For instance, in one such embodiment, next to each input field for demographic information, a set of three radio buttons is placed. One is labeled “Keep Private,” another is labeled “Make Available,” and the third is labeled “Forecast Payments.” A single button is placed in a prominent position labeled “Run Payment Forecast.” (Note that the invention is not limited to this particular wording or set of buttons; these are given for example only.)

When the user presses “Run Payment Forecast,” a simulation is run which tells the user approximately how much he can expect to be paid if he makes available all the information currently marked “Forecast Payments.” This is accomplished, in some embodiments, by running an experimental auction using the available agents, where the “Forecast Payments” data is made available to the agents. For greater accuracy, some embodiments store expired agents for further accuracy in these predictions. For example, collections of agents that were available at several points in time in the past can be run in a series of auctions, and the average winning bid calculated and used in present a forecasted payment to the user.

Other embodiments may use other methods for forecasting payments. The output in any case allows the user to get a sense of how much money he will make if he makes the “Forecast Payments” data available. Various embodiments may show the amount per hour of viewing, per month, or my other units.

In general, there are many approaches to auctioning off a resource which are well-known to practitioners of ordinary skill in the arts of economics and game theory. The present invention is not limited to any particular auction method. However, it should be noted that the Vickrey auction, which involves giving the resource to the highest bidder but at the second-highest price, has the advantage of motivating the agents to give their we valuations of the resource in their bids. The difference between the highest bid and the second highest bid can then be looked at as the cost of motivating this revealing of information, which leads to a more reliable auction process if the agents are truly rational. For more information, see [1] or other studies on the subject of Vickrey and other types of auctions. Note however that in embodiments where the bids do not consist of a limited resource such as money, agents will be motivated to reveal their true valuation even when the winning bid is the price paid; in such cases the advantages of a Vickrey auction is lost.

In some embodiments, a Vickrey auction is used, in accordance with the algorithm described in Hal R. Varian, “Economic Mechanism Design for Computerized Agents,” <http://www.sims.berkeley.edu/-hal/people/hal/papers.html>. In other embodiments, other auction models can be used.

Information Available to Agents

In most embodiments, the same agent for a particular ad can be sent to all users. It will have the intelligence given it by its creators to appropriately bid depending on the user s expected interest in the advertisement, depending on the information that the agent can glean from the user's machine—demographic information if the user has chosen to record it, information regarding the page currently being viewed, if that is available, etc.

Note that identifiers of the ads themselves can be built into the agents. In some embodiments, however, the agent environment stores the information regarding which agent is associated with which ads, so the agent does not need to have that information built into it (however, in cases where a single agent represents multiple ads, an identifier must still be included to link a given bid with the particular ad it corresponds to).

Information made available to agents by the agent environment may include any or all of, but is not limited to:

Demographic info such as age, sex, income, etc.

Work-related info such as job title, business of company (for instance, in the form of a SIC code), etc.

Whether the ad(s) the agent is responsible for has already been viewed; how many times; how long ago; whether it has been acted on such as being clicked on.

For agents that can store alterations to a persistent state, the results of each bid.

The identity (for instance, URL) and/or subject area of the page currently being viewed. To enable the subject area of a page to be made available to agents, some embodiments store a table on the user's machine which maps URL's to subject areas; others enable agent environments to query remote servers to determine the subject area (for instance, a company such as Yahoo which stores categories for URL's could be the supplier of this subject area information). Other embodiments examine the text of a page to determine its subject area. (Existing technology in text retrieval can be used for this purpose; a “concept vector” can be built representing the concepts corresponding to words occurring on each page, and a distance calculated between such concept vectors and concept vectors representing different subject areas; the closest match is considered to be the subject area for a page. Practitioners of ordinary skill in the art of text retrieval will know how to do this.) The invention is not dependent upon any particular means for determining the subject area of a page.

The current level of activity of the user; for instance, if the user has not touched his keyboard in 15 minutes he is probably not looking at the screen, and therefore a low bid should be placed on any new ads to show.

In some embodiments, all agents are presented with the same types of data. In others, agents specifically request the data types they desire. In some such embodiments, running an agent is therefore a two-step process; in the first step, the agents is asked what data it wants, and in the second, it receives it (for instance, as an XML-formatted string).

In some embodiments, agents can be custom-tailored for particular users.

This is useful in cases where the advertiser has some information about the user, purchase history information being a prime example.

The usefulness of customizing an agent in this way needs to be weighed against the perceived privacy risks (the actual privacy risks are minimal or even nonexistent).

The general approach is to use certain identification information to determine whether an advertiser has information about a user whose machine will be running an agent and to enable that advertiser to make a custom agent for that user. This identifying information may be, for example, name and/or address information that an online retailer is likely to already have if the user is a customer.

In some embodiments more accurate identification methods may be used. For instance, in one embodiment, a visitor to an advertiser site is presented with a button that enables him to choose to see ads more highly customized to his needs, when he does see ads from that advertiser. Clicking the button causes a unique identifier to be stored in both the user's machine and in the advertiser's servers which represent that user (depending on the embodiment, this identifier may take the form of a cookie on the user's machine). The identifier is then used to enable agents custom-built for a particular user to be sent into that user's machine.

In some embodiments, such a unique user identifier (UUI) is capitalized on as follows. When the advertiser has a new ad to show, it creates a general agent for use on user machines where no UUI is present, and it also generates a set of agents corresponding to its set of stored UUI's. These agents are then transported over the network to the agent environment vendor. When the agent environment vendor uploads new agents to the agent environment on a particular machine, it first requests any existing UUI's together with an identifier of the advertiser that originated the UUI (alternatively, this information may be embedded in the UUI itself). It then finds any agents which have been created for those UUI's by the corresponding advertisers, and downloads those agents to the agent environment.

An example of agents customized in this way is given elsewhere in this document, in which an agent is customized to address the probable interests of someone who has purchased a large number of Linux-based computers. Such an agent should be designed to bid an ad for a new Linux computer higher while he is visiting a site devoted to reviews of Linux-based hardware than while visiting an online flower delivery service, due to the user's probable difference in mind set while browsing the two locations.

In embodiments where there is no UUI, and, for instance, only the user's name is available, and the agent is going to go to all users with that name, the agent can still bid somewhat higher for the Linux computer ad than it would for names with no association to that interest. Note that an agent constructed to reflect this kind of purchase history (or other) information as stored by the advertisers can still also use the demographic (or other) information available to it when it is running in the agent environment on the user's machine; such information is used to further refine the bid.

While there are any number of ways purchase history information can be encoded into an agent customized for a particular user, one such means will be given here. This example will also describe a variety of agent which integrates several types of information into a bid.

First, the agent contains a neural network which takes demographic information such as age, income level, occupation, etc. and generates a number of cents (which may be fractional) corresponding to how interested the advertiser is in reaching that user based on that private information. This neural net was trained using paid volunteers with varying demographics who rated the ad.

Second, there is a table that maps the current browsing location—for instance, by domain name to a number of cents. (If the agent is representing an ad for Linux boxes, this number is high if the domain name is slashdot.org, since the Web site at that domain focuses on Linux and open-source issues, and low of it domain name is 800-flowers.com.) Third, there is a fixed number of cents which is derived from the purchase history. (Again using the example of the Linux box ad, if the advertiser has already sold the user a large number of Linux boxes, this term will be high.) These three terms are added together, resulting in the agent's bid at a particular time.

An agent can alternatively receive names of items bought, prices, etc., in real time, via network connection, rather than have that data incorporated into the agent. Again, this information transfer can be keyed upon a UUI, or, if none is present, on name and/or address. In further embodiments, the agent can have a request facility built into it so that, depending on the particular location the user is browsing, it can ask for different information. It can use, for instance, XML to format a request for specific information. An example of a use for this would be an advertiser, such as Sears, which carries a vast variety of products. If a user is browsing a car magazine site, the agent may send a request to Sears for automobile-related purchase history information. Of course, depending on the technologies involved in the particular embodiment, the request may have to use the agent environment vendor's servers as an intermediary; for instance in a Web browser, a Java applet-based agent environment may only be allowed to make socket connections with the agent environment vendor's servers and not directly with the advertisers servers. Name and (possibly) address can be used (without any other user-specific information being emitted from the user's machine) as the key for the request, enabling the advertiser to return the needed data. One of ordinary skill in the art of design and programming in network computing will know how to construct these features.

Information Flowing Out of the Agent Environment

When a bid is accepted in the agent environment, in most embodiments a notice is immediately sent back to the agent environment vendor indicating which ad was shown. On the Internet, this may be accomplished through standard socket-based communications. This information is used for performance measurement and billing records.

(Note that in some embodiments, it is possible that multiple agents will be able to bid to display the same ad. For example, multiple vendors might be used to provide agent software for a single advertisement; each vendor's agent might be more attuned to the interests of different demographic clusters. In such cases, and possibly in other cases, the identity of the agent itself is sent back to the agent environment vendor.)

In general, depending on the particular embodiment, data is sent back to the agent environment vendor and/or to the advertisers which enables them to measure the performance of the agents. One value in this is to enable an advertiser to deploy several agents simultaneously representing the same ad (usually they will be deployed to different users) and see which one gives the best performance (for instance, the lowest cost per click-through).

Pre-targeting

In some embodiments, there is a payment to enable agents to run in a user's machine. This reduces the workload on user machines, and can increase overall revenues. For example, some embodiments require advertisers to pay to place agents in user machines. This can be achieved by means of a fixed fee per user machine; the agents are distributed randomly to various users. The advertiser can specify how many machines it would like its agents to run in, and pay accordingly. In some further embodiments, payments are based upon resources used, in addition to (or instead of) the per-machine fee.

For instance, there may be a payment per kilobytes of memory used. In some embodiments, advertisers bid to place their agents. There may be a minimum payment; the bids are then in addition to that payment. For instance, in one embodiment the user has a fixed number of “slots” for agents. Bidding takes place to decide which agents will be allowed to run in those slots. To facilitate this process, some embodiments enable users to make some or all of their personal information available to advertisers, or the advertiser specifies the number of user machines he would like his agents to run on, and the agent environment vendor. For example, a user might allow his income level to be shared. Then advertisers for premium products can use that information to decide how much to bid for one of the agent slots. The agent will still be able to use the other information available to it, when running in the agent environment, to decide how much to bid for an actual display.

In some embodiments, there is a fee for making a bid, in addition to or instead of the fee for running an agent on a user machine.

The advertiser can randomly distributes the agents to the appropriate number of user machines. One reason to increase the number of machines is to decrease the amount of time it takes to achieve a desired number clicks.

General Technical Considerations for Agent Environments

A software environment must be created which supports the needs of the agents. In one class of embodiments, agents take the form of executable code. For instance, in some embodiments where the agents are executable code, the agent environment is written in Java. An interface is defined for agents; code that will act as an agent must implement this interface. Then agents written elsewhere may be instantiated in the agent environment using the facilities in java.lang.reflect. In Java-based embodiments, security is usually achieved by means of the Java Virtual Machine's built in mechanisms. The Java libraries also contain streaming facilities, allowing classes that implement Java.io.Serializable to be streamed with ObjectOutputStream.writeObjecto and ObjectInputStream.readObjectQ; this is used to enable agent environments running on the user's machine to receive and run agents which are created by advertisers. In Internet-based embodiments, these are usually transmitted by means of sockets and the TCP/IP protocol.

In some other embodiments, the environment is written in a language such as C, and a scripting interpreter is embedded in it. Some further embodiments use the Python language for the scripting interpreter. For security, some such embodiments execute agents through instances of Python RExec class, which makes it impossible for the agents to directly open sockets, access the disk, etc. Like Java, Python provides facilities which enable objects to be streamed from one location to another, and similarly, these facilities, known to programmers of ordinary skill in the art of Python programming, are used to enable agents written by advertisers to be sent to be run in agent environments on user machines.

Most modem operating systems provide multithreading facilities whereby the agents can run independently and simultaneously within the agent environment. Languages such as C and Python have libraries which allow access to multithreading (Java has multithreading built in).

Some embodiments devote different execution threads to different agents. They all run simultaneously, taking advantage of multiple processors on user machines which have that feature. In others, they are run sequentially when an event occurs which calls for new bids to be generated.

The agent environment needs to communicate with the outside world in order to receive the agents, and in some embodiments, information that may be used by the agents.

The most important information that the user's machine needs to receive from the outside world is the agents themselves.

To facilitate this, some implementations keep a communications socket for this purpose open at all time, and either poll it or have an execution thread wait on it, which can receive new agents ads at any time. Others request new agents and ads at intervals, for instance, once per day. In some embodiments, advertiser servers can interact directly with the agent environment in the user's machine through secure communications; in others, user machines only interact with the agent environment supplier's servers, which is both more secure and more efficient.

Some embodiments enable agents to have persistent state; that is, between executions of agent code, the state of the agent is stored, usually to disk, so that it can learn over time. For instance, if an agent “knows” that it recently placed its ad and that the user clicked on it, it will probably generate a very low bid next time. Java and Python both provide facilities wherein the current state of objects can be “streamed” and stored.

Not all embodiments involve agents which could be considered to be executable code.

For instance, in some embodiments the “agents” are actually neural networks; that is, an agent is considered to be the information comprising the weights, topology, and any other needed information to instantiate a neural network. Advertisers generate this information for each ad; inputs are defined in a standard way by the agent environment vendor, and the networks are trained to use this information to generate an output bid. These agents are usually trained by the advertiser. The agent environment instantiates agents from the data, presents them with the input data, executes them, and processes the output bids. So in this model neural networks are used to map particular user characteristics to particular ads.

In a sense, the agent environment constructs a “container” for the agent data, which is not an agent itself but may be thought of as the DNA of an agent constructed in the agent environment.

As another example, an agent may be a vector showing the correlation between interest in the ad with each category of info on the user's machine. The container would take that information and calculate a probability or other predictor regarding confidence that the user in question will have interest in the ad. A table is sent along with the agent that maps these probabilities into the amount to bid. Note that no separate agent process or thread needs to actually be created; an iterator could simply do these calculations for each vector in sequence. The end result is the same as if a agent were used, but the details are different.

In the discussions of using Java and Python for the agent environment, some security issues were addressed. However, it is not always necessary to be concerned about hostile agents since only advertisers specifically authorized by the service provider can create agents that will run in the agent environment; advertisers that provide hostile agents are subject to legal remedy and therefore are not expected to abuse their privileges. This security may be accomplished in a number of ways. In one approach, all agents are sent from the advertisers' servers to the agent environment supplier's servers and on to the agent environments running on the users' machines. In each case, secure communications are established between the entity using cryptographic techniques known to those of ordinary skill in the art of network security. For instance, the agents can be hardcoded to only accept communications from a particular domain name (or even a particular IP address), and similarly, the agent environment supplier may only accept communications from particular domains or IP addresses.

Agent Environment Implementation within Web Browsers

Netscape has defined a standard interface for plug-ins, which is software code that may be downloaded by the user and is subsequently loaded into the Web browser. It has no restrictions against such actions as reading from and writing to the user's hard disk, where his demographic information may stored, for instance, in a format defined by the CPEX standard at <http:\\www.cpex.org>.

The agent environment resides in the plug-in. Data provided to each agent by the agent environment includes whatever demographic, behavioral, or other types of available data. The plug-in itself is responsible for storing the locations that the user visits for which the plug-in was active on the user's local storage.) For instance, in one embodiment, data is passed from the agent environment into the agents using XML format (this may be particularly convenient since the CPEX standard stores personal data in that format). The data may include the URL of the Web page currently being viewed; this may be updated every time the user goes to a new page. Note that in the Netscape Communicator browser (3.0 and better), the LiveConnect package is used to enable plugins to communicate with their environment, such as using JavaScript to send the current page URL into the plug-in.

In some embodiments, the agent environment supplier is alerted if the user does not have the plug-in installed. One simple way to do this is by supplying a cookie which serves as indicator if it is installed—if the cookie is not there, it is assumed that the plug-in is not installed.

If the plug-in is not installed, an ad may be displayed by other methods. Furthermore, the user may be alerted to the fact that the plug-in is not installed. For instance, in such cases, one embodiment displays a box next to the banner ad, with wording to the effect of: “If you would like ads which are more relevant to your interests, and to have the ads chosen in your own computer so that no personal information needs to leave your computer, click here.” Clicking on the box takes the user to a page where instructions are given on how to download the plugin.

Internet Explorer does not currently contain the LiveConnect package. So, although it does allow plug-ins to operate, different means may need to be used to get the URL of the currently-viewed page into the plug-in. This can be accomplished, for instance, by putting that information into the file accessed by the SRC parameter of the EMBED tag for each page.

Also, for Internet Explorer, an ActiveX control rather than a Netscape-style plug-in may be used to accomplish the same purposes. The advertisers do not need to know whether the agent environment is a Netscape plug-in or an ActiveX control; any differences are handled by the agent environment supplier. Of course, the HTML code of the Web page to be viewed is different depending on the type of agent environment. This contingency may be handled, for instance, by means of a JavaScript function that determines the browser type, determines if the plug-in or ActiveX control has been downloaded, and generates the appropriate HTML during the parsing phase.

The HTML can be generated by the document.writeQ function within <SCRIPT>tags. (If the browser is Netscape Communicator 3.0 or better, for example, the plugins array can be used to check and see whether the plug-in is available.) The generated HTML can simply request an ad from the server if no plug-in or ActiveX control is available, or can create an instance of the plug-in or ActiveX control if one is there.

In some embodiments, a traditional Java applet is used as the agent environment. A disadvantage of that approach is that the code and agents need to be downloaded every time the user visits a site which contains the applet. In some cases, it will be stored in a local cache after the first download, but that still requires reading it from disk and reinitializing it. However, future developments may make this approach more practical.

Implementation within Stand-alone Ad-displaying Processes

While implementation within a Web browser has certain advantages—it enables the ad banners people are already used to seeing to be created with superior privacy and targeting accuracy than current technology—it is not the only possible implementation.

Free Internet service providers (ISP's), for example, frequently supply a separate advertising region on the user's screen which is associated with the Web browser.

Such implementation do not have the same hurdles to jump as browser-based implementations do. For instance, they don't need to deal with the plug-in interface, they don't need to deal with the security restrictions imposed on Java applets which run in a Web browser, etc. There is total flexibility in coding these separate applications. Some such embodiments are written in Java and use reflection to instantiate advertiser-supplied agents. Some use Python or other languages.

Such non-browser embodiments do not necessarily need to be on the Web or even on the Internet Set-top TV boxes are one excellent example, in cases where the technological infrastructure exists to show different ads to different people depending on decisions made in the set-top box.

Definitions and Other Considerations

The term “sockets,” and other TCP/IP related terms, as used in this document should not imply limitation to TCP/IP communications or a dependence on the Internet or any other technology. Equivalent technology in other types of networking system are also within the scope of the present invention.

Money and “cents” as used herein do not refer only to American currency and can even involve some abstract unit (in most cases such units ultimately are related to one or more currencies).

“Page” as used herein may refer to any kind of unit of output, even a unit of speech, a speech method, a menu and associated descriptive text, etc.

“Site” as used herein can mean any kind of collection of screens

“Advertiser” may refer to other things than advertisers. It can refer to any entity that can create agents. For example, it may be an advertising agency; in others it can be an advertising “hub” company that receives ads from multiple advertisers and/or agencies and forwards them to the agent environment vendor.

“Advertisement,” as used herein, refers not only to traditional advertisements, but can also include items which may be recommended to users. For instance, in one embodiment, a movie theatre organization may use the system to recommend movies for people to see based on their demographic information and behavioral information (for instance, movies they have asked for more information on or rated in the past). The display of the name or other representation of the recommended movie is an “advertisement.” Similarly, mp3's or music CD's could be recommended.

“Agent” as used herein may refer to a typical software agent, but may also refer to some information that is used in the agent environment in calculating a bid amount for a particular ad. In a sense, it can be thought that an agent is instantiated on the fly based upon this information. For instance, the interconnections and weights in a neural net, where the agent environment will construct a neural net and use it to generate bids, are together referred to as an “agent” for the purposes of this specification.

It should be noted that while the configuration described herein, where agents run in each user's machine, is good for protecting privacy, other variations are possible within the scope of the invention. As an example, the user demographic and behavioral information may be downloaded to the agent environment vendor using such technologies as those envisioned by CPEX Network. The agent environments exist on the vendor's servers, and inter-agent bidding occurs there. This enables all parties to take advantage of any agent technologies to target their ads, not just that provided by the advertising network vendor; each advertiser, with the help of its own agent technology suppliers, then takes its own responsibility for targeting advertisements, just as today advertisers compete on the basis of the compelling nature of the advertisements their hired ad agencies create.

In one embodiment, software on the user's machine makes the micropayment for seeing some content. For example, it fills a cybercoin wallet as time goes on. Alternatively,. the money may go to the ISP, as partial of full payment. The hub vendor can query the ISP to find out how much is owed so it doesn't overpay.

The agent environment can send back each agent's success rate, and be sent a factor to increase bids (or get sent a new agent).

In one embodiment, movie studios can recommend movies to people in a dedicated movie site.

There are implementations of the present invention where the agent runs once and outputs a fixed bid, and other implementations where it creates a rule set such as “on this site bid so and so, and in general bid so-and-so”.

An agent can advantageously take advantage of log-in information. Such information can be used to attach data files to the particular person, and to send the name and address from the current person to servers to get agents for each person.

The service provider may provide agents on behalf of advertisers.

The agent environment itself can adjust things so that a bid for a slot is discounted if the user has already clicked or if the ad has been shown recently. Or, sub-components can be supplied, to be built into agents, to do that adjusting.

It is recognized that a patent is made more readable and useful as it contains more concrete examples, even if the creation of those examples would be obvious to any practitioner of ordinary skill in the art.

This written description includes numerous examples of the present invention, these examples are meant to illustrate, and not limit, the scope of the present invention. Those skilled in the art will appreciate and learn from this description that many other embodiments of the present invention can be implemented.

What is claimed is:

1. A method for targeting advertising, including:
storing advertisement targeting information on a client; and
selecting at the client an advertisement for display based upon the advertisement targeting information stored at the client.

2. A method for targeting advertising, including:
receiving information provided by a client;
selecting an agent based upon the information provided by the client;
sending the selected agent to the client, wherein the agent is adapted to select an advertisement at the client based upon information stored at the client.

3. A method for targeting advertising, including:
receiving information about a recipient;
selecting an agent based upon the information received about the recipient;
sending the selected agent to a client, wherein the agent is adapted to select an advertisement based upon private information stored at the client.

4. A method for targeting advertising, including:
sending an agent to a client;
receiving an advertisement request from an agent, wherein the request is based upon information stored at the client;
sending an advertisement to the client based upon the advertisement request.
